(19) United States
(12) Patent Application Publication
(10) Pub. No.: US 2020/0119482 A1
(43) Pub. Date: Apr. 16, 2020

(54) Connector

(71) Applicant: Tyco Electronics Japan G.K., Kawasaki (JP)

(72) Inventor: Takafumi Kubo, Kawasaki-shi (JP)

(73) Assignee: Tyco Electronics Japan G.K., Kawasaki (JP)

(21) Appl. No.: 16/599,637

(22) Filed: Oct. 11, 2019

(30) Foreign Application Priority Data
Oct. 12, 2018 (JP) 2018-0193097

(51) Int. Cl. H01R 13/24; H01R 13/52; H01R 24/86; H01R 13/41

(52) U.S. Cl. CPC H01R 13/2421; H01R 13/521; H01R 2107/00; H01R 24/86; H01R 13/41; H01R 13/2471

(57) ABSTRACT

A connector includes a plurality of contacts each having a distal end portion, a housing having a cavity, a plurality of coil springs exposed in the cavity, and a seal member positioned at the distal end portions of the contacts and sealing the housing. The contacts are positioned in the cavity. The distal end portion of each of the contacts is slidable in a projecting direction and in a direction opposite to the projecting direction. Each of the coil springs independently biases the distal end portion of one of the contacts in the projecting direction. The seal member allows the contacts to slide in the projecting direction and in the direction opposite to the projecting direction.

### CROSS-REFERENCE TO RELATED APPLICATION

This application claims the benefit of the filing date under 35 U.S.C. § 119(a)-(d) of Japanese Patent Application No. 2018-193097, filed on Oct. 12, 2018.

### FIELD OF THE INVENTION

The present invention relates to a connector and, more particularly, to a connector having a contact slidable with respect to a housing.

### BACKGROUND

A pogo-pin type contact is known in which a pin slidable in a projecting direction and in a direction opposite thereto is provided in a cylindrical metal case. The pin is urged in the projecting direction by a spring member positioned in the case. The pogo-pin type contact establishes electrical continuity with a mating contact by a distal end of the pin projecting from the case abutting against a pad or the like of the mating contact and being pressed thereagainst.

Japanese Patent Application No. 2017-204351A discloses a connector having a plurality of pogo-pin type contacts arranged therein. Because the connector has the pogo-pin type contacts arranged therein, it is difficult to configure a connector having a small contact pitch. In addition, the pogo-pin type contact risks water ingress into the case.

### SUMMARY

A connector includes a plurality of contacts each having a distal end portion, a housing having a cavity, a plurality of coil springs exposed in the cavity, and a seal member positioned at the distal end portions of the contacts and sealing the housing. The contacts are positioned in the cavity. The distal end portion of each of the contacts is slidable in a projecting direction and in a direction opposite to the projecting direction. Each of the coil springs independently biases the distal end portion of one of the contacts in the projecting direction. The seal member allows the contacts to slide in the projecting direction and in the direction opposite to the projecting direction.

### BRIEF DESCRIPTION OF THE DRAWINGS

The invention will now be described by way of example with reference to the accompanying Figures, of which:

FIG. 1 is a sectional perspective view of an unmated state of a first connector and a second connector to be mated with the first connector according to an embodiment;

FIG. 2 is a perspective view of the first connector and the second connector of FIG. 1 in a mated state;

FIG. 3 is a sectional perspective view of the first connector and the second connector of FIG. 1 in a state between the unmated state and the mated state; and

FIG. 4 is a sectional perspective view of an unmated state of a first connector and a second connector to be mated with the first connector according to another embodiment.

### DETAILED DESCRIPTION OF THE EMBODIMENT(S)

The present disclosure will be described hereinafter in further detail with reference to the following embodiments, taken in conjunction with the accompanying drawings. In the specification, the same or similar reference numerals indicate the same or similar parts. The description of the embodiments of the present disclosure with reference to the accompanying drawings is intended to explain the general inventive concept of the present disclosure, and should not be constructed as a limitation to the present disclosure.

In the following detailed description, for the sake of explanation, numerous specific details are set forth in order to provide a thorough understanding of the disclosed embodiments. It will be apparent, however, one or more embodiments may also be practiced without these specific details. In other instances, well-known structures and devices are illustrated schematically in order to simplify the drawing.

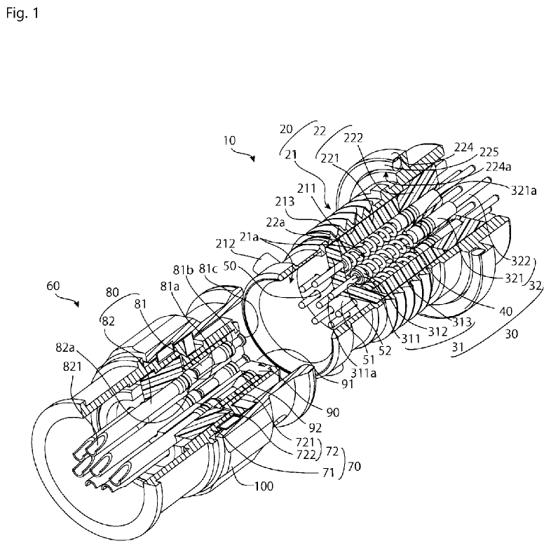

A first connector 10 according to an embodiment and a second connector 60 matable with the first connector 10 are shown in FIG. 1. The first connector 10 has a plurality of contacts 30 accommodated in a housing 20. Each contact 30 has a slide pin 31 and a fixed pin 32. The slide pin 31 has a distal end portion 311 projecting toward the second connector 60 that is a mating connector, a larger diameter portion 312, and a rear end portion 313. In the shown embodiment, the distal end portion 311 has a rod shape. The fixed pin 32 has a cylindrical portion 321 in which a portion of the rear end portion 313 of the slide pin 31 is slidably received, and a connection portion 322 soldered to a circuit board (not shown). The cylindrical portion 321 has a supporting portion 321a formed so as to have a larger diameter at a portion in a longitudinal direction of the cylindrical portion 321.

The housing 20, as shown in FIG. 1, has an outer metal housing 21 and an inner insulating housing 22. The outer metal housing 21 has a substantially-cylindrical first cavity 21a, the insulating housing 22 is accommodated in the first cavity 21a, and the plurality of contacts 30 are positioned in a second cavity 22a of the insulating housing 22. The insulating housing 22 includes a front first housing 221 and a rear second housing 222, and has a structure bringing an inner peripheral face of the second housing 222 into contact with an outer peripheral face of each fixed pin 32. The supporting portion 321a of the fixed pin 32 has a larger diameter and is press-fitted in the second housing 222, and thereby the fixed pin 32 is so supported as to be incapable of sliding.

As shown in FIG. 1, a coil spring 40 is positioned around the rear end portion 313 of the slide pin 31. In the case of a so-called pogo pin, a spring member is positioned in a case in which a pin projecting from the case is slidably accommodated, whereas the coil spring 40 is so positioned as to be exposed in the second cavity 22a. The diameter of a single contact 30, including the coil spring 40, is reduced, and thus the pitch of the contacts 30 is reduced. This coil spring 40 is positionally restricted at a front end thereof by the larger diameter portion 312 of the slide pin 31, and positionally restricted at a rear end thereof by a front end of the fixed pin 32. The coil spring 40 urges the slide pin 31 in a projecting direction of the front end portion 311.

A seal member 50, shown in FIG. 1, is positioned around the front end portion 311 of the slide pin 31. The seal member 50 is composed of a single component called a family seal in contact with an outer peripheral face of each slide pin 31 and an inner peripheral face 211 of the first cavity 21a of the metal housing 21. The seal member 50 allows the front end portion 31 of each contact 30 to slide and seals to prevent water ingress into the first connector 10. The slide pin 31 is projecting by the action of the coil spring 40 such that the larger diameter portion 312 abuts against a rear face 52 of the seal member 50. The coil spring 40 biases the slide pin 31 in the projecting direction.

As shown in FIG. 1, a boss 212 projecting outward and an external thread portion 213 are formed on an outer wall face of the metal housing 21 constituting the housing 20. The boss 212 is for locating and locking with respect to the second connector 60 to be mated with the first connector 10. In an embodiment, the first connector 10 is inserted into a hole provided in a panel and fixed with a nut. The external thread portion 213 is an external thread portion to be mated with the nut.

A flange portion 224 is provided on a rear portion of the metal housing 21 as shown in FIG. 1. The flange portion 224 has a groove 224a formed circumferentially for receiving an O-ring 225. When the first connector 10 is fixed to the panel, with the O-ring 225 positioned in the groove 224a of the flange portion 224, the first connector 10 is inserted into the hole in the panel and so fixed as to hold the panel between the flange portion 224 and the nut. Thereby, water ingress is also prevented between the hole in the panel having the first connector 10 inserted therein and the first connector 10.

The second connector 6, as shown in FIG. 1, has a similar structure to the first connector 10 with a plurality of contacts 80 accommodated in a housing 70. Each contact 80 has a front pin portion 81 on the side of the first connector 10 and a fixed portion 82 far from the first connector 10. The fixed portion 82 has a cylindrical shape, and a solder cup 821 having a notched shape as shown is formed in a rear end portion of the fixed portion 82. In an embodiment, a distal end of a wire is soldered to the solder cup 821.

The contact 30 of the first connector 10 has the pin-shaped connection portion 322 to be soldered to the circuit board, and the contact 80 of the second connector 60 has the solder cup 821 to which the wire is soldered. In another embodiment, the first connector 10 may be provided with a solder cup, and the second connector 60 may be provided with a pin-shaped connection portion. Alternatively, both the first connector 10 and the second connector 60 may be provided with a pin-shape connection portion or a solder cup.

The fixed portion 82 of the contact 80 of the second connector 60, as shown in FIG. 1, has a supporting portion 82a formed so as to have a larger diameter at a portion in a longitudinal direction of the fixed portion 82, like the fixed pin 32 of the contact 30 of the first connector 10. Furthermore, also like the first connector 10, the housing 70 has a metal housing 71 and an insulating housing 72. The insulating housing 72 is composed of a front first housing 721 and a rear second housing 722. Further, the supporting portion 82a of the fixed portion 82 having a larger diameter is press-fitted in the second housing 722, and thereby the fixed portion 82 is immovably supported.

As shown in FIG. 1, two larger diameter portions, a larger diameter portion 81a located on a rear side as viewed from the first connector 10 and a larger diameter portion 81b located on a front side as viewed from the first connector 10, are formed on the front pin portion 81 of the contact 80. A planar pad 81c facing a distal end of the contact 30 of the first connector 10 shown in FIG. 1 is formed at a distal end of the front pin portion 81.

The second connector 60 has a seal member 90, as shown in FIG. 1. It should be noted that, for ease of viewing, hatching of the cross section of the seal member 90 is omitted. This seal member 90 is a single component called a family seal, like the seal member 50 of the first connector 10. A front face 91 of the seal member 90 is flush with the pad 81c at the distal end of the front pin portion 81, and the larger diameter portion 81b of the front pin portion 81 abuts against a rear face 92 of the seal member 90.

The second connector 60, as shown in FIG. 1, has a substantially-circumferential outer shell 100 surrounding the housing 70. The outer shell 100 is turnable within a predetermined angle with respect to the housing 70, and a so-called bayonet type mounting structure for mating the second connector 60 with the first connector 10 is configured in the outer shell 100.

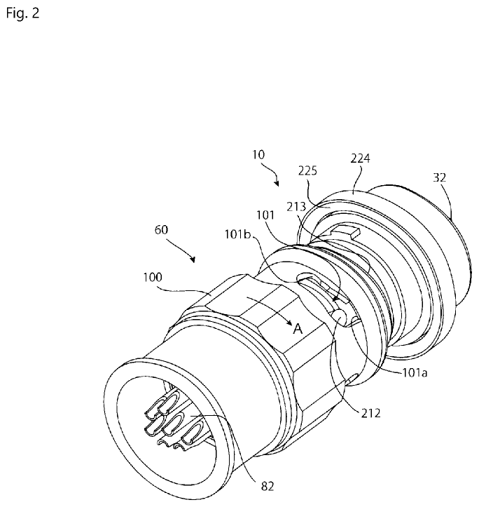

In order to mate the second connector 60 with the first connector 10, as shown in FIG. 2, the direction of the second connector 60 is aligned with the first connector 10 such that an entrance 101a of a cam groove 101 of the outer shell 100 faces the boss 212. Then, as shown in FIG. 2, the outer shell 100 is pressed against the first connector 10 such that the boss 212 is inserted into the cam groove 101. With the outer shell 100 pressed against the first connector 10, the outer shell 100 is turned in a direction of an arrow A. Thereupon, with this turn of the outer shell 100, the boss 212 moves to the rear of the cam groove 101. At that stage, by releasing the hand from the outer shell 100, the boss 212 gets into a depressed portion 101b of the cam groove 101, and thus the second connector 60 is stably connected to the first connector 10. In order to unmate the second connector 60 from the first connector 10, an operation reverse to what is described above is performed; the boss 212 is released from the depressed portion 101b by pressing the outer shell 100 to the first connector 10, the outer shell 100 is turned in a direction opposite to the direction of arrow A, and then the hand is released. In this manner, the second connector 60 is unmated from the first connector 10.

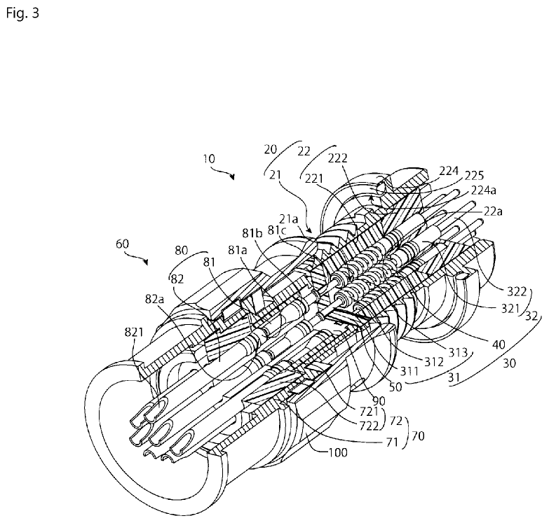

In the course of mating the second connector 60 with the first connector 10, as shown in FIG. 3, first, a distal end 311a of the contact 30 of the first connector 10 abuts against the pad 81c at the distal end of the contact 80 of the second connector 60. Then, as the coil spring 40 is compressed, the slide pin 31 of the contact 30 slides rearward until the distal end 311a reaches the same position as a front face 51 of the seal member 50. This causes the contacts 30 and 80 to come into contact with each other with a predetermined contact pressure to establish electrical continuity.

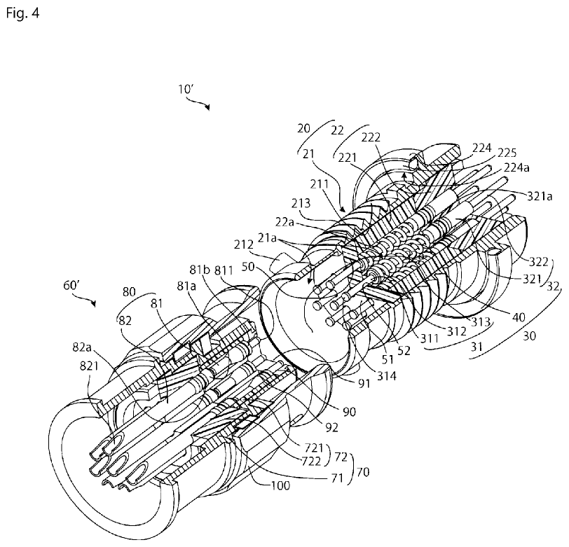

A first connector 10′ according to another embodiment and matable with a second connector 60′ is shown in FIG. 4. The same reference numerals as those used in the embodiment of FIGS. 1-3 are used for denotation, and thus only a difference from the embodiment of FIGS. 1-3 will be described in detail.

The first connector 10′ shown in FIG. 4 has a pad 314 at a distal end of the distal end portion of each contact 30. The pad 314 is a planar pad facing the distal end of the contact 80 of the second connector 60′ that is a mating connector.

A distal end 811 of the front pin portion 81 of the contact 80 constituting the second connector 60′ shown in FIG. 4 has a pin shape in which the tip projects toward the first connector 10′. The pad 81c, which is provided in the second connector 60 shown in FIG. 2, is not formed at the distal end 811. Further, the distal end 811 of the front pin portion 81 of the contact 80 in FIG. 4 slightly projects from the front face 91 of the seal member 90. Alternatively, the distal end 811 of the front pin portion 81 may be a face flush with or slightly withdrawn from the front face 91 of the seal member 90. In that case, a portion on the front face 91 side of a hole of the seal member 90 having the front pin portion 81 inserted therein is an opening wide enough to allow insertion of the pad 314 of the contact 30 of the first connector 10′ shown in FIG. 4.

The second connector 60′ shown in FIG. 4 is a mating connector for the first connector 10′. Upon mating, the pad 314 at the distal end of the contact 30 of the first connector 10′ abuts against the distal end 811 of the contact 80 of the second connector 60′. Then, the pad 314 of the first connector 10′ is pressed to slide rearward. The configuration may be such that the first connector 10′ has the pad 314 and the pin-shaped distal end 811 of the contact 80 of the second connector 60′ presses the pad 314.

Both in the embodiment of FIGS. 1-3 and in the embodiment of FIG. 4 described above, as compared with the connector having so-called pogo pins arranged therein, a connector is achieved that enables a smaller pitch while fulfilling the same function as the pogo pins and moreover prevents water ingress.

What is claimed is:

1. A connector, comprising:
a plurality of contacts each having a distal end portion, the distal end portion of each of the contacts is slidable in a projecting direction and in a direction opposite to the projecting direction;
a housing having a cavity, the contacts are positioned in the cavity;
a plurality of coil springs exposed in the cavity, each of the coil springs independently biasing the distal end portion of one of the contacts in the projecting direction; and
a seal member positioned at the distal end portions of the contacts and sealing the housing, the seal member allowing the contacts to slide in the projecting direction and in the direction opposite to the projecting direction.

2. The connector of claim 1, wherein the seal member is a single component in contact with an outer peripheral face of each of the contacts.

3. The connector of claim 2, wherein the seal member is in contact with an inner peripheral face of the housing.

4. The connector of claim 1, wherein the distal end portions of the contacts each have a pin shape.

5. The connector of claim 4, wherein the distal end portions of the contacts each abut against a planar pad of a mating contact.

6. The connector of claim 1, wherein distal end portions of the contacts each have a pad.

7. The connector of claim 6, wherein the distal end portions of the contacts each face a pin-shaped distal end of a mating contact.

8. The connector of claim 1, wherein each of the contacts has a slide pin and a fixed pin.

9. The connector of claim 8, wherein the slide pin has the distal end portion, a larger diameter portion, and a rear end portion.

10. The connector of claim 9, wherein the fixed pin has a cylindrical portion in which the rear end portion of the slide pin is slidably received.

11. The connector of claim 10, wherein the cylindrical portion has a supporting portion with a larger diameter than a rest of the cylindrical portion.

12. The connector of claim 11, wherein the housing has an outer metal housing and an inner insulating housing accommodated within the outer metal housing.

13. The connector of claim 12, wherein the plurality of contacts are positioned within the inner insulating housing, the fixed pin of each of the contacts is press-fitted in the inner insulating housing and incapable of moving with respect to the inner insulating housing.

14. The connector of claim 10, wherein each of the coil springs is held between the larger diameter portion of the slide pin and a front end portion of the fixed pin of one of the contacts.
